(19) United States
(12) Patent Application Publication
(10) Pub. No.: US 2012/0060557 A1
(43) Pub. Date: Mar. 15, 2012

(54) Cut Product, in Particular Diamond, with Improved Characteristics and Method for Manufacturing Such a Product

(76) Inventor: Eva van Looveren, Halle-Zoersel (BE)

(21) Appl. No.: 13/202,527

(22) PCT Filed: Feb. 19, 2010
(86) PCT No.: PCT/EP2010/052121

§ 371 Date: Nov. 16, 2011

(30) Foreign Application Priority Data
Feb. 20, 2009 (BE) 2009/0101
Feb. 20, 2009 (BE) 2009/0102

(51) Int. Cl. A44C 17/00; B28D 5/00

(52) U.S. Cl. 63/32; 125/30.01

(57) ABSTRACT

Cut product manufactured from a (semi) precious stone material, more particularly from natural or synthetic diamond, comprising a lower part (pavilion) with a bottom end (culet); an upper part (crown) having a number of girdle bezel facets and a top end (a point with table width 0 or a top surface (table) with a table width); and a girdle between said lower part and said upper part, wherein said lower part comprises a number of girdle pavilion facets which describe a first angle α1 relative to the plane of the girdle and a number of culet facets which each describe a smaller second angle α2 relative to the plane of the girdle; and wherein the girdle bezel facets are in a twisted position with respect to the girdle pavilion facets in the sense that the bezel facets have perpendicular bisectors which are not coplanar with the perpendicular bisectors of the girdle pavilion facets; and wherein the ratio of the table width and the width of the girdle is 0 to 0.40.

The present invention relates to a cut product manufactured from a (rough) natural or synthetic (semi)precious stone material, more particularly from natural or synthetic diamond. The cut product can be an unfinished over-measured cut product or a finished cut product. The present invention also relates to a method for treating a (rough) natural or synthetic (semi)precious stone material, in particular natural or synthetic diamond, for obtaining a cut product.

Note that, in the case of synthetic diamond, the starting material (substrate) can be manufactured by any technical process, such as for instance chemical vapour deposition (CVD) or an HTHP process (high pressure high temperature process). An example of a CVD process is the process used by Apollo Diamonds Inc.

### PRIOR ART

A cut of a precious stone is defined by its facets. These facets have a specific shape, a specific location and a specific angular position relative to each other. The combination of the specific shape, location and angular position of the different facets defines the cut. The angular position of the different facets of a cut are defined by the proportion parameters of this cut.

The value of a cut diamond is determined to a significant extent by the four Cs: Cut, Clarity, Carat and Colour. These are respectively the cut, the clarity, the weight and the colour of a cut diamond.

‘Cut’ is understood to mean the finish of the stone. The shape in which the stone is cut forms part of this. The finish relates to the quality of the cutting and the ratios of the cut form. FIG. 1A illustrates schematically a prior art stone. The essence lies in the correct ratios and the refinement of the cut stone 20. The ratios are understood to mean the height 34 of crown 24, the crown angle β, the depth 35 of pavilion 25, the table reflection, the ratio of the girdle 22 relative to the total depth of the stone. Refinement is understood to mean the precise overall finish. How regular is the girdle, is the culet heavy or light, are there differences in symmetry between crown 24 and pavilion 25, do the facets connect precisely to each other, is the culet exactly in the centre or is the table off-centre? All these factors have a direct influence on the play of light in the stone. In contrast to the clarity, colour and partially also the weight, the cut is man-made. It is therefore a large price-determining factor in the four Cs, since a stone with a good round weight, which is flawless and has the best colour in the form of a brilliant cut seems to be a top stone. However, if the stone has been cut too deep (nail) or too shallow (fish-eye), the play of light in the stone is dead, and the stone has a lower value. In short, the finish is of great importance because it eventually brings out the most important aspect of the stone: the brilliance and the play of colour in all its resplendence.

‘Clarity’ is the clarity of brightness of cut diamond. The stone can have both internal and external flaws. The internal flaws usually consist of carbon residues which have not fully crystallized, or glets (internal fissures). They occur in many different forms but also in various grades of intensity. Growth lines which show the structure of the rough stone. There are also external characteristics, such as bearding which is left when the stone is cut too hard. It is also possible that natural remains when the stone is cut too little. Both characteristics can be seen on the girdle. All these characteristics determine the clarity of the stone, which is divided into different categories: Flawless, VVS1, VVS2, VS1, VS2, SI, Pique 1, Pique 2, Pique 3. The assessment hereof is carried out by the trained eye of the diamond merchant or in laboratories, under the microscope.

The weight of precious stones (Carat) is expressed in Carat (1 carat=0.2 gram). The carat is sub-divided into 100 points and is always expressed to two decimals, for instance 0.24 carat or 24 points.

Colour is always subjective. The whiter the colour, the higher the price. The colour is determined on the basis of a set of so-called master stones. This is a set of stones assessed by various leading diamond merchants and having different colours in the highest grades, which are deemed as a standard. The assessment usually takes place by eye. Electronic assessments are also possible nowadays.

The valuation of cut diamonds is however more complex in practice than measuring or determining the 4 Cs. In addition to the combination of the different Cs, the assessment of the colour, the clarity and the cut is often subjective. The finish and the life of a stone are moreover also taken into account. The life of a stone is a subjective measure of the brilliance of a diamond. The value of a cut diamond cannot therefore be fully determined on the basis of the 4 Cs. In this context reference is made to colour, brilliance, fire, scintillation and life as the optical characteristics. Reference is made to the work of Tolkowsky.

The optical characteristics of a cut diamond are explained by various physical effects, of which the most important are the overall internal reflection and refraction of light on the surfaces. Since diamond has a very high refractive index (2.42), with a very small critical angle as a result, total reflection of the light will occur on many cut surfaces. The light will only leave the diamond at a small number of cut surfaces. In this context the cut has an extremely great influence on the refraction and the overall internal reflection. FIGS. 2A-C illustrate the path followed by the incident light. In the case of too great a pavilion height 35—see FIG. 1B—or too small a pavilion height—see FIG. 2C—light will escape, whereas an ideal cut—see FIG. 2A—results in a maximum internal reflection, whereby no light escapes and optimum optical characteristics are obtained.

It is generally accepted that Tolkowsky performed the first mathematical calculations which took into account the optical characteristics of a diamond. Tolkowsky calculated the ‘ideal’ proportion parameters of a brilliant. In other words, the proportion parameters are the degrees of freedom of a cut. Table 1 describes the limits of the different proportion parameters per category in respect of the assessment of the optical characteristics of conventional diamond cuts.

TABLE 1

| | | | Very | | Very | | |
|---|---|---|---|---|---|---|---|
| | Fair | Good | good | Excellent | good | Good | Fair |
| Bezel angle (β) | up to 25.9 | 26.0 to 27.9 | 28.0 to 31.9 | 32.0 to 36.0 | 36.1 to 37.7 | 37.8 to 40.0 | 40.1 and higher |
| (degrees) | | | | | | | |
| Pavilion angle | up to 38.4 | 38.5 to 39.5 | 39.6 to 40.5 | 40.6 to 41.8 | 41.9 to 42.1 | 42.2 to 43.1 | 43.2 and higher |
| (α) (degrees) | | | | | | | |
| Table size | up to 49% | 50 to 51% | 52 to 53% | 54 to 62% | 63 to 66% | 67 to 70% | 71% and higher |
| (% of girdle) | | | | | | | |
| Crown height | up to 8.5% | 9.0 to 10.5% | 11.0 to 11.5% | 12.0 to 16.0% | 16.5 to 18.0% | 18.5 to 19.5% | 20.0% and higher |
| Pavilion height | up to 39.5% | 40.0 to 41.0% | 41.5 to 42.5% | 43.0 to 44.5% | 45.0% | 45.5 to 46.5% | 47.0% and higher |
| Girdle thickness | up to 0.5% | 1.0 to 1.5% | 2.0% | 2.5 to 4.0% | 4.5% | 5.0 to 7.5% | 8.0% and higher |
| Culet size | | | | 0.0 to 0.9% | 1.0 to 1.9% | 2.0 to 3.9% | 4.0% and higher |
| Overall height | up to 52.9% | 53.0 to 55.4% | 55.5 to 58.4% | 58.5 to 62.5% | 62.6 to 63.9% | 64.0 to 66.9% | 67.0% and higher |
| Sum α and β | up to 67.9 | 68.0 to 69.9 | 70.0 to 72.4 | 72.5 to 77.0 | 77.1 to 78.0 | 78.1 to 80.0 | 80.1 and higher |
| (degrees) | | | | | | | |
| Crown half length | up to 30% | 35% | 40% | 45 to 55% | 60% | 65% | 70% and higher |
| Pavilion half length | up to 60% | 65 to 0% | 75% | 75 to 85% | 85% | 90% | 95% and higher |
| Fish-eye effect | | | | Excellent | | Good | Fair |
| KIB-effect | | | | Excellent | | | Fair |

The cutting of new diamonds is thus limited by the above proportion parameters.

In order to obtain the best cut diamond starting from a given rough diamond, use is typically made of the existing techniques as follows.

1) Preparatory Steps: Analysis of the Stone

During this phase the rough stone is examined for specific properties which are relevant in arriving at the best cut solution, such as geometry, weight, colour, clarity (local flaws such as inclusions in the stone) and so on. Scanners are usually used as aid to facilitate this examination in order to map a three-dimensional (3D) image of the stone. The flaws may or may not be precisely localized here in the 3D image. During this phase the best final result will be determined that fits in with the rough stone.

2) Rough Processing Steps

The first rough processing steps are intended for the purpose of removing the excess material within broad margins. A table surface is first cleaved or sawn in conventional manner.

FIGS. 20A-20B illustrate how, during a preparatory phase, the best cut 1001 is determined and how a first table surface is sawn. FIG. 20A shows a perspective view of a rough stone 1000 in which is shown a possible cut 1001 for this rough stone 1000. The cut 1001 has a table 1002, a girdle 1003 and a culet 1004. As shown in FIG. 11B, the first saw plane 1100 extends parallel to table 1002 at a small distance therefrom.

The stone is then typically blocked (rough cross work), i.e. the large excess portions are removed.

3) Further Shaping

The further cross work then takes place, wherein in the case of a round stone the pavilions (typically eight), the bezels (typically eight) and the girdle are for instance arranged.

4) Fine Polishing Work (Corrections to Already Present Rough Facets and Brilliandering)

These latter steps—in which the facets arranged during the cross work are typically further polished and in which additional small facets are cut—are still performed manually according to the current techniques using a polishing disc.

A number of interim checks will typically be carried out during steps 2-4 in order to further refine the location and geometry of the cut stone.

### SUMMARY OF THE INVENTION

The present invention has for its object to provide a cut product, wherein the optical characteristics as defined above are better than for a cut product which is cut according to the existing indicated proportion parameters.

According to an embodiment of the invention there is provided a cut product manufactured from a (semi)precious stone material, more particularly from natural or synthetic diamond, comprising a lower part (pavilion) with a bottom end (culet); an upper part (crown) having a number of girdle bezel facets and a top end (a point with table width 0 or a top surface (table) with a table width); and a girdle between said lower part and said upper part. The lower part comprises a number of girdle pavilion facets which describe a first angle α1 relative to the plane of the girdle and a number of culet facets which each describe a smaller second angle α2 relative to the plane of the girdle. The girdle bezel facets are in a twisted position with respect to the girdle pavilion facets in the sense that the bezel facets have perpendicular bisectors which are not coplanar with the perpendicular bisectors of the girdle pavilion facets. Further the ratio of the table width and the width of the girdle is preferably 0 to 0.40.

Applicant has surprisingly found that by providing such facets and the table dimensions, the light is reflected optimally in the stone, this resulting in improved optical properties. Note that the table dimensions are clearly smaller than what is usual according to conventional views (see the table above) and that angle α2 is smaller than is usual.

According to a preferred embodiment, viewed in a top view of the stone or viewed along the circumference of the girdle, each bezel facet is centred between two adjoining girdle pavilion facets.

According to an embodiment of the invention, a number of girdle bezel facets are provided between the top end and the girdle, wherein this number is equal to the number of girdle pavilion facets and the girdle bezel facets are twisted relative to the girdle pavilion facets through a twist angle γ, seen along the circumference of the girdle, see e.g. FIG. 6B. Differently formulated a first plane through the centre of each bezel facet and the central vertical axis of the cut product describes a twist angle γ with respect to a second plane through the centre of a following girdle pavilion facet and the central vertical axis of the cut product. This is particularly useful when the number of bezels and pavilions is even.

According to a preferred embodiment the twist angle γ is optimized as a function of the dimensions and/or the model (round, pear, square, rectangular, . . . ) of the stone in order to obtain a reflection of the lower part in the bezels and/or in the table.

In the case where the cut product is a round stone, the twist angle γ is preferably substantially equal to 180 degrees divided by the number of girdle pavilion facets. More generally the average of the twist angles γ for each girdle pavilion facet with respect the adjacent girdle bezel facet seen in a certain direction along the girdle is substantially equal to 180 degrees divided by the number of girdle pavilion facets. Possible values for the twist angle are preferably larger than 5 degrees, and more preferably larger than 10 degrees.

According to a variant in which this aspect is further developed, the twist angle is optimized as a function of the dimensions, and particularly as a function of the length, height and width of the stone, in order to obtain a reflection of the lower part in the bezels and/or in the table.

According to an embodiment of the cut product of the invention, the lower part comprises a number of girdle pavilion facets which describe an angle α1 relative to the plane of the girdle and a number of culet facets which each describe a smaller second angle α2 relative to the plane of the girdle; wherein the average second angle α2 lies between 28 and 38 degrees; and/or wherein the ratio of the table size and the size of the girdle is 0 to 0.40.

Applicant has surprisingly found that by providing such facets and with a suitable choice of the smaller second angle and of the table dimensions, the light is reflected optimally in the stone, this resulting in improved optical properties. Note that the table dimensions are clearly smaller than what is usual according to conventional views (see the table above) and that angle α2 is smaller than is usual.

According to a preferred embodiment, the average second angle α2 lies between 25 degrees and 35 degrees, more preferably between 29 degrees and 33 degrees, and is for instance about 31 degrees. According to an even better variant, each second angle α2 lies between 28 degrees and 35 degrees, more preferably still between 29 degrees and 33 degrees, and is for instance about 31 degrees.

According to yet another aspect, the invention is distinguished in that the ratio of the table size and the size of the girdle is 0 to 0.3, and preferably either a point or a table with a table size amounting to between 10 and 30% of the size of the girdle.

The size of the table and the orientation of the facets of the upper and lower parts are further preferably optimized in order to reflect the lower part in at least a number of the facets of the upper part, and typically in the table bezel facets and/or the table and/or the girdle bezel facets.

The girdle pavilion facets are typically located above the culet facets, wherein each culet facet adjoins the bottom end and each girdle pavilion facet adjoins the girdle. According to a possible embodiment, the culet facets adjoin the girdle pavilion facets, although it is also possible for additional pavilions facet to be provided between the girdle and culet facets. Preferably at least three, and more preferably at least four, and for instance six, seven or eight or more girdle pavilion facets and culet facets are arranged. The culet facets can comprise a number of pavilion facets and/or a number of half facets, see e.g. FIG. 6A where the culet facets consist of eight pavilion facets 115 or FIG. 11A where the culet facets consist of sixteen half facets 2010. In the case where the culet facets consist of a number of half facets, said number is advantageously equal to the double of the number of girdle pavilion facets.

According to a possible embodiment, the average first angle α1 of the girdle pavilion facets lies between 15 and 80 degrees. Angles α2 and/or α1 can be further optimized for a cut product with the greatest possible volume.

According to another aspect, an embodiment of the product of the invention is distinguished in that the upper part is a crown with table bezel facets and girdle bezel facets, which girdle bezel facets describe a first angle β1 relative to the plane of the girdle, and which table bezel facets describe a second, smaller angle β2 relative to the plane of the girdle. The average first angle β1 of the girdle bezel facets relative to the plane of the girdle preferably lies between 35 degrees and 50 degrees, more preferably between 39 degrees and 43 degrees, and is most preferably about 41 degrees. The average second angle β2 preferably lies between 5 and 50 degrees, preferably between 30 and 50 degrees, and for instance between 31 and 41 degrees. Note that each bezel can comprise a table bezel facet which adjoins the table and a girdle bezel facet which adjoins the girdle, wherein extra bezel facets can optionally also be included between the table bezel facets and the girdle bezel facets.

According to a preferred embodiment, the girdle bezel facets are located below the table bezel facets, wherein each table bezel facet adjoins the top end and each girdle bezel facet adjoins the girdle. The girdle bezel facets can adjoin the table bezel facets, although it is also possible to provide additional facets therebetween. Preferably at least three, more preferably at least four and for instance six, seven or eight girdle bezel facets and table bezel facets are arranged. The number of girdle and table bezel facets and the orientation thereof is preferably optimized for a cut product with the largest possible volume, taking into account of course all the parameters which are important for the value of the stone.

According to yet another aspect, the product of the invention is distinguished in that the ratio of the height of the cut product and the width of the girdle lies between 0.60 and 1, and more preferably between 0.75 and 0.85. Another interesting parameter is the height of the stone at the edge of the table, and the ratio of this height relative to the table width. This is because this parameter will also play a part in obtaining an optimal reflection of the lower part in the upper part.

According to yet another aspect, the cut product of the invention is distinguished in that the ratio of the height of the girdle and the width of the girdle is 0.02 to 0.1. The girdle is preferably provided with a large number of facets in order to obtain a good reflection for light beams which are incident in the stone and reflected to the culet facets via the girdle.

According to the preferred embodiment of the invention, the lower part, and in particular the culet, is cut as a brilliant. Note that it is advantageous that the culet is cut as a brilliant because the culet side is reflected in the upper part.

Another object of the present invention is to provide a new method which makes it possible, starting from the same rough stone, to obtain a better final result than is possible using the traditional methods.

According to an embodiment of the method of the invention a method is provided for treating a (semi)precious stone material, in particular diamond, for obtaining a cut product comprising:

a lower part (pavilion) with a number of facets and with a bottom end (culet);

an upper part (crown) with a number of facets and a top end (a point or a top surface (table)); and

a girdle between lower part and upper part. Instead of the table, the bottom end (the culet) is used as reference for arranging the facets of the cut product.

In the history of diamond cutting, which dates back hundreds of years, the table has always been used as reference plane for arranging the rough facets (during the cross work) of the desired cut product. In surprising manner however, applicant has made the discovery that a better final result, i.e. a more valuable cut stone, can be obtained by beginning the cutting at the culet. Particularly the carat weight and the play of light in the stone can be considerably improved compared to stones cut according to the prior art. Beginning the cutting work from the culet allows in the first instance the volume of the lower part of the stone to be kept as large as possible. The upper part of the stone can further be modified for an optimum play of light (an optimum brilliance) in the stone, wherein the volume of the upper part is simultaneously also kept as large as possible.

According to the preferred embodiment of the method of the invention, as first rough facets of the cut product at least two cross facet groups of in each case at least one cross facet are arranged between the bottom end and the girdle. According to a further option, at least two cross facet groups of at least two adjoining cross facets lying one above another are arranged from the bottom end up to the girdle, wherein a lower cross facet of each cross facet group adjoins the bottom end and an upper cross facet of each cross facet group is intended to adjoin the girdle.

By making use of cross facet groups having at least two cross facets the volume of the lower part can be considerably enlarged. This is because the angles which the different cross facets describe relative to the plane of the girdle and the location of the transition from one cross facet of a cross facet group to a subsequent cross facet located thereabove in this group can be optimized for a maximum volume.

According to an aspect of the method of the invention, a pavilion group is arranged in each case between two cross facet groups as seen along the periphery of the girdle, wherein each pavilion group has at least one facet. These pavilion facets can thus be arranged after the cross facet groups have been arranged.

The method of the invention may further comprises any of the following features, alone or in combination:

at least three cross facet groups, and preferably at least four cross facet groups are arranged between the bottom end and the girdle;

the number of cross facets of each cross facet group and the orientation thereof is optimized for a cut product with the largest possible volume;

for the upper part at least three bezel groups, each consisting of at least one bezel facet, are arranged between the girdle and the top end;

each bezel group consists of at least two adjoining bezel facets lying one above another, of which a lower bezel facet adjoins the girdle and an upper bezel facet adjoins the top end;

the number of bezel facets of each bezel facet group and the orientation thereof is optimized for a cut with the largest possible volume;

the cut is further finished, wherein the cross facets are cut as a brilliant;

the pavilion facets are cut as a princess.

The invention also relates to a cut product obtained according to an embodiment of such a method.

According to an embodiment of a cut product according to the invention, comprising a lower part with a number of facets and with a bottom end (culet); an upper part; and a girdle between lower part and upper part, the cut product is distinguished in that at least two cross facet groups of in each case at least one cross facet are arranged between the bottom end and the girdle while facets have not yet been arranged on the upper part.

According to a further developed embodiment, at least two, and preferably at least three or four cross facet groups, each with at least two adjoining cross facets lying one above another, are arranged between the bottom end and the girdle, wherein a lower cross facet of each cross facet group adjoins the bottom end and an upper cross facet of each cross facet group adjoins the girdle.

Advantageous embodiments of the cut product according to the invention may comprise any of the following features, alone or in combination:

at least three, and preferably at least four cross facet groups are arranged between the bottom end and the girdle;

each lower cross facet describes an angle α2 relative to the plane of the girdle lying between 15 and 50 degrees, preferably between 25 and 38 degrees, more preferably between 27 and 33 degrees, and being most preferably about 31 degrees;

each upper cross facet describes an angle α1 relative to the plane of the girdle lying between 35 and 80 degrees;

a pavilion group is arranged in each case between two cross facet groups as seen along the periphery of the girdle, wherein each pavilion group has at least one pavilion facet;

the at least one pavilion facet describes an angle α3 relative to the plane of the girdle lying between 15 and 80 degrees;

the angles α1 and/or α2 and/or α3 is/are optimized for a cut with the largest possible volume;

the upper part has a number of facets and a top end, wherein the upper part has at least three bezel facet groups, each consisting of at least one bezel facet between the girdle and the top end;

each bezel facet group consists of at least two adjoining bezel facets lying one above another, of which a lower bezel facet adjoins the girdle and an upper bezel facet adjoins the top end;

each lower bezel facet describes an angle β1 relative to the plane of the girdle lying between 30 and 60 degrees, preferably between 35 and 50 degrees, more preferably between 39 and 43 degrees and being most preferably about 41 degrees;

each upper bezel facet describes an angle β2 relative to the plane of the girdle lying between 5 and 50 degrees;

the number of bezel facets of each bezel facet group and the orientation thereof are optimized for a cut product with the largest possible volume;

the top end is a table having a table width which lies between 1 and 40 percent of the width of the girdle, and preferably between 10 and 30 percent; or between 65 and 99 percent of the width of the girdle, and preferably between 75 and 95 percent; or the top end is a point (Note that these percentages do not lie within the normally chosen percentages of the table width of a diamond. A table width is traditionally chosen which lies between 50 and 60 percent of the width of the girdle);

the ratio of the distance between bottom and top end and the width of the girdle lies between 0.60 and 1, and more preferably between 0.75 and 0.85;

the table width and the orientation of the facets of the upper and lower parts are optimized to reflect the lower part in at least a number of the facets of the upper part;

the cross facets are cut as a brilliant;

the pavilion facets are cut as a princess.

The upper part preferably comprises at least three bezel facet groups, each consisting of at least one bezel facet between the girdle and the top end, and preferably of at least two adjoining bezel facets lying one above another, of which a lower bezel facet adjoins the girdle and an upper bezel facet adjoins the top end. Advantageous angles β1 and β2 of the upper part are as mentioned in the paragraph above.

Applicant has made the surprising discovery that by using the correct ratios and angles it is possible to reflect the pattern of the lower part in each of the main facets of the upper part. The play of light in the stone can in this way be considerably improved.

According to an embodiment of the invention a finished cut product is manufactured making use of a cut product as described above. The finished cut product preferably has the further property that the cross facets are cut as a brilliant and/or that the pavilion facets are cut as a princess. The skilled person will however appreciate that the invention can be applied for any type of cut.

The invention will be further elucidated on the basis of a number of non-limitative exemplary embodiments of the cut products according to the invention, with reference to the accompanying drawings.

### DESCRIPTION OF THE FIGURES

FIGS. 1A-C illustrate the effects of the cut on the reflection and refraction of incident light;

FIG. 2 is a schematic side view of an embodiment of a cut according to the invention, indicating the proportion parameters which are important in characterizing the cut;

FIG. 3 is a schematic side view of a preferred embodiment of a diamond according to the invention;

FIG. 4 illustrates the reflection of the lower part in the upper part in an embodiment of a diamond cut as a brilliant according to the invention;

FIG. 5 shows the internal reflection of incident light on the girdle in an embodiment of a diamond according to the invention;

FIGS. 6A, 6B and 6C illustrate respectively schematic perspective views of an exemplary embodiment of a finished round diamond, of a finished round diamond with bezels which are twisted relative to the pavilions, and of a finished pear diamond according to the invention;

FIGS. 7A and B illustrate respectively the contours of a round diamond and pear diamond cut according to an embodiment of the invention compared to those of a conventionally cut round diamond and pear;

FIGS. 8A-8D illustrate top views which are possible in an embodiment of the stone according to the invention;

FIGS. 9A-9E illustrate respectively a top view and possible top or bottom views of a pear diamond cut according to the invention;

FIGS. 10A and B illustrate respective bottom views of an advantageous round diamond and of an advantageous pear diamond according to the invention;

FIGS. 11A, 11B and 11C illustrate respectively a schematic perspective view, a schematic top view and a schematic bottom view of an exemplary embodiment of a finished round diamond with bezels which are twisted relative to the pavilions;

FIG. 12 illustrates respectively a schematic perspective view of another exemplary embodiment of a finished round diamond with bezels which are twisted relative to the pavilions;

FIGS. 13A, 13B, and 13C illustrate respectively a schematic perspective view, a schematic top view and a schematic bottom view of an exemplary embodiment of a finished square diamond according to the invention with bezels which are twisted relative to the pavilions;

FIGS. 14A-C are side views of an unfinished diamond after performing the cross work, of a finished cut diamond, and of the finished cut diamond of FIG. 14B rotated over 45 degrees, respectively;

FIGS. 15A-B are bottom views of the stone shown in FIG. 1A, and of the finished stone shown in FIG. 1B, respectively;

FIG. 15C corresponds to the bottom view of FIG. 2A wherein the final result of FIG. 2B is shown in broken lines;

FIGS. 16A-C illustrate top views which are possible in an embodiment of the stone according to the invention;

FIGS. 17A-17F illustrate bottom views which are possible in an embodiment of the stone according to the invention;

wherein in a number of figures possible main facets of the cross work are drawn in broken lines;

FIGS. 18A-B illustrate respectively a bottom view of an embodiment of a pear diamond according to the invention; and of a variant thereof; wherein possible main facets of the cross work are drawn in broken lines;

FIGS. 19A-D illustrate possible bottom views of a pear diamond cut according to the invention;

FIGS. 20A-B illustrate respectively a side view, a rotated side view and a top view of a rough stone showing the saw planes as used in a traditional method.

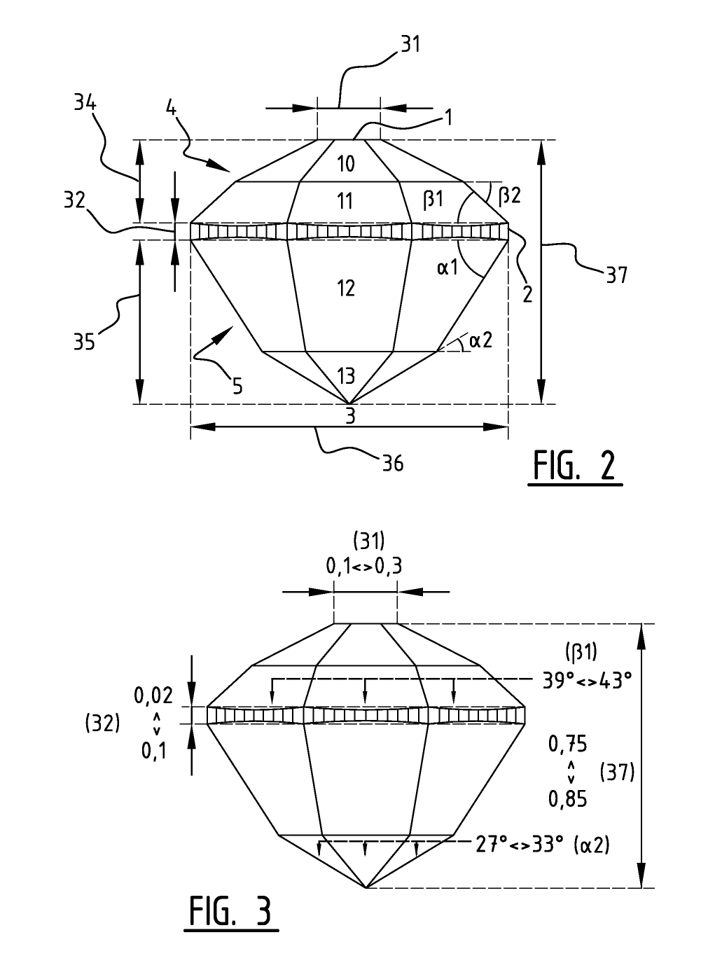

A diamond is generally characterized by the presence of a table 1, a girdle 2 and a culet 3, as shown in FIG. 2. The area between the table and the girdle is referred to as the crown 4. The area between the culet and the girdle is referred to as the pavilion 5. The crown and the pavilion are made up of facets 10-13. The facets located between table facet 1 and girdle 2 are referred to as bezels. In the shown embodiment there are eight bezels and each bezel comprises a table bezel facet 10 which adjoins table 1 and a girdle bezel facet 11 which adjoins girdle 2. The facets located between culet 3 and girdle 2 are referred to as pavilions. In the shown embodiment there are eight pavilions: eight culet facets 13 adjoining the culet and eight girdle pavilion facets 12 adjoining the girdle.

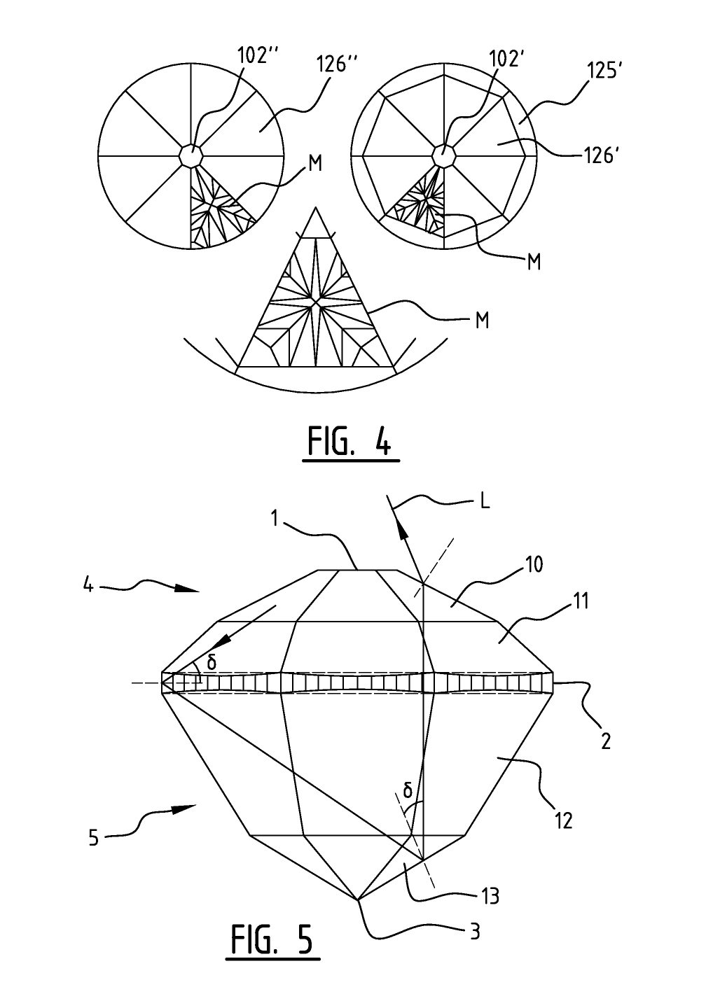

In the embodiment of FIG. 2 two angles of inclination can be defined on the pavilion side: the girdle pavilion facet incline α1, comparable to the pavilion incline as defined for a conventional stone, and culet facet incline α2, being the angle α2 which a culet facet forms with the girdle. Further present on the bezel side in this embodiment are two inclines: the girdle bezel facet incline β1, being the angle β1 which a girdle bezel facet forms with the girdle, and table bezel facet incline β2, being the angle β2 which the table bezel facet forms with the girdle. FIG. 3 illustrates the possible values for the average culet facet incline α2, which lies between 27 and 33 degrees, and for the average girdle bezel facet incline β1, which lies between 39 and 43 degrees. The variation from the average value normally amounts to no more than 10%, preferably no more than 5%, and most preferably no more than 1%.

FIG. 3 illustrates a variant with table, although variants with a point as top end likewise lie within the scope of the invention. The table width 31 or size expressed as a percentage or fraction of the overall (average) width 36 of girdle 2 is preferably chosen between 10% and 30%, as illustrated in FIG. 3. The overall height 37 expressed as a percentage or fraction of the overall (average) width of the girdle is preferably chosen between 75% and 85%, as illustrated in FIG. 3. Finally, the girdle thickness 32 is expressed as a percentage or fraction of the overall (average) width 36 of the girdle, preferably chosen between 2% and 10%, as illustrated in FIG. 3.

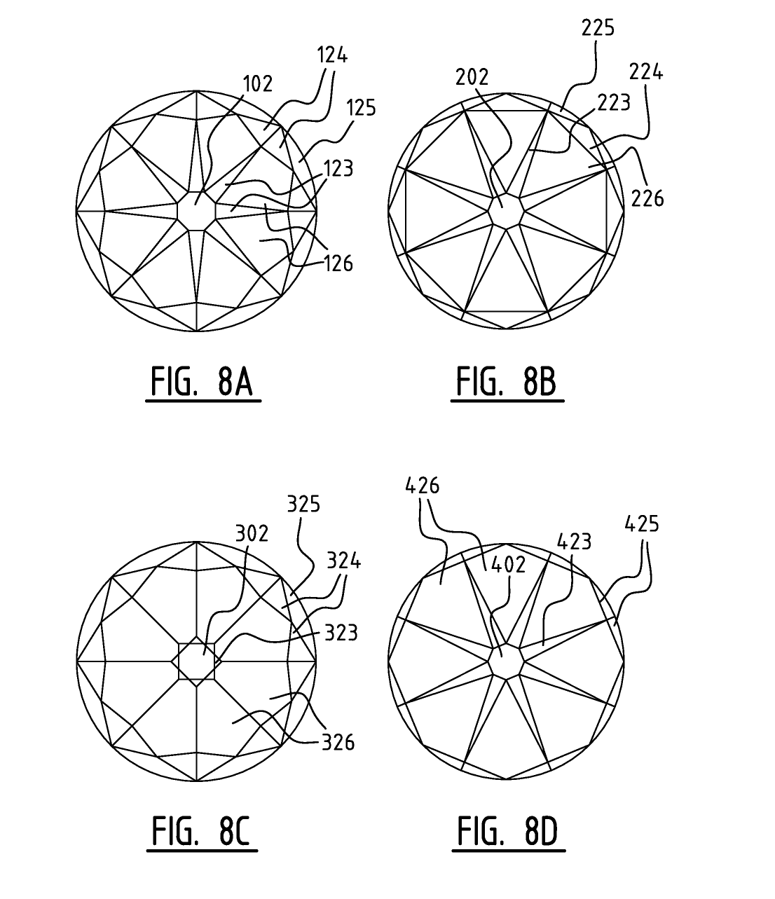

It will be apparent that the embodiments described here can be further finished (for instance by being cut as brilliants) without departing from the scope of the invention. FIGS. 6A, 6B and 6C illustrate three examples of a finished stone, here respectively a round diamond, a round diamond with rotation of the bezels relative to the pavilions, and a pear.

FIGS. 6A and 6B show a round diamond with a table 102, a girdle 103 and a culet 104, and with:

eight table bezel facets 126 and eight girdle bezel facets 125;

eight girdle pavilion facets 114 and eight culet facets 115, here also pavilion facets.

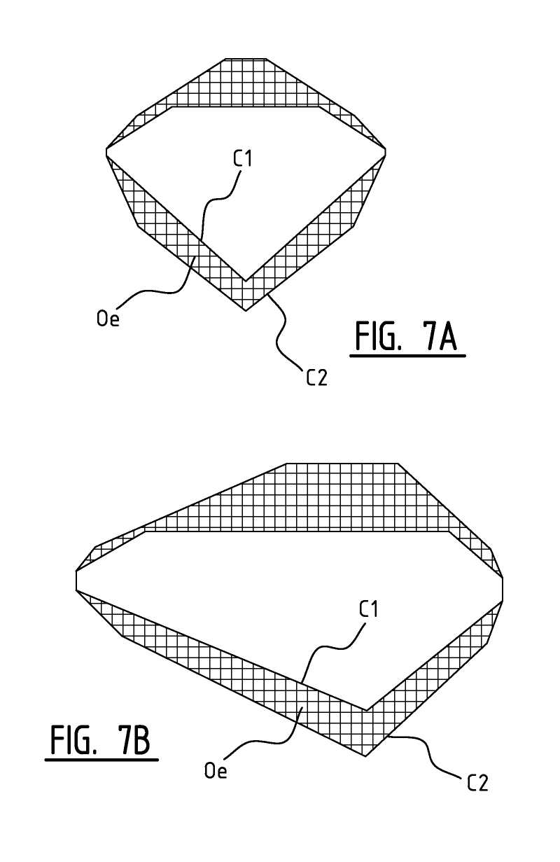

In the variant of FIG. 6B the pavilions are twisted through a twist angle γ relative to the bezels. This angle can be further optimized in order to obtain the best possible reflection of the lower part in the upper part, taking into account the principles illustrated in FIG. 5, see below. During the fine cutting work the star facets 123 and half facets 124 are arranged on the crown, and four additional facets 117, 118 were arranged in each case on the pavilion, although the skilled person will appreciate that there may also be more or fewer facets.

FIG. 6C shows a variant in a pear shape, wherein corresponding facets are designated with the same numeral to which 1000 is added. This stone will again preferably be optimized in order to obtain the best possible reflection of the lower part in the upper part, taking into account the principles illustrated in FIG. 5, see below. It will further be apparent to the skilled person that the girdle typically comprises a large number of small facets, which have been omitted in FIGS. 6A, 6B and 6C in order not to overload the drawing.

Compared to the conventional proportion parameters (see Table 1) it is apparent that each of the described proportion parameters of the present invention differs therefrom. More specifically, in determined embodiments of the present invention the table is smaller and the overall height and the girdle thickness are usually greater than proposed for the conventional cuts. In possible embodiments of the present invention the culet facet angle α2 is likewise smaller than the conventional pavilion angle (typically 41 degrees) and the girdle bezel facet incline p1 is typically larger than the conventional bezel incline (typically 34 degrees).

Despite these parameters differing from the conventional values, the described preferred embodiments are nevertheless characterized by improved optical characteristics which can be objectively determined by means of commercially available software applications.

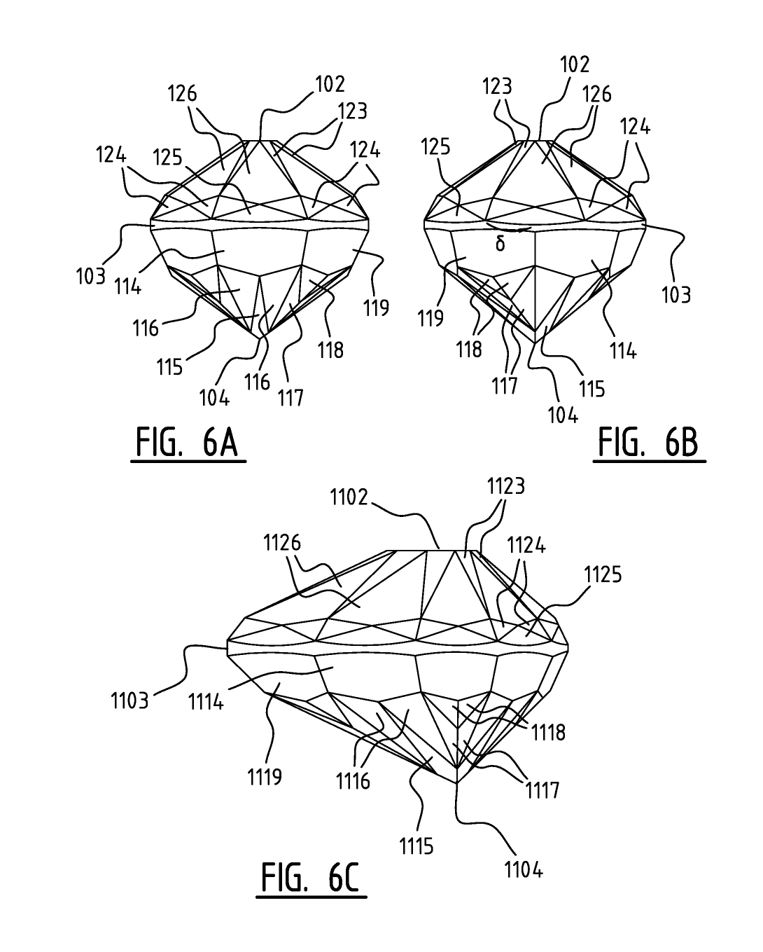

The above described values for the angles of the culet facets and the girdle bezel facets, as well as the table size, will moreover allow at least the central part of the pattern of the pavilion to be reflected in the main facets of the crown, in the girdle bezel facets and in the table, as illustrated in FIG. 4. The central part of the pattern M of the lower part is reflected in the main facets 126′, 126″ of the upper part. This reflection is made possible by choosing a sufficiently small table in combination with suitable angles for the facets 126′, 126″ of the upper part and for the facets of the lower part. This pattern will typically further also be visible in table 102′, 102″ and in the lower facets 125′, 125″. This reflection is typically made possible by choosing a sufficiently small table in combination with a culet facet incline and a girdle bezel facet incline as stated in the preferred embodiments.

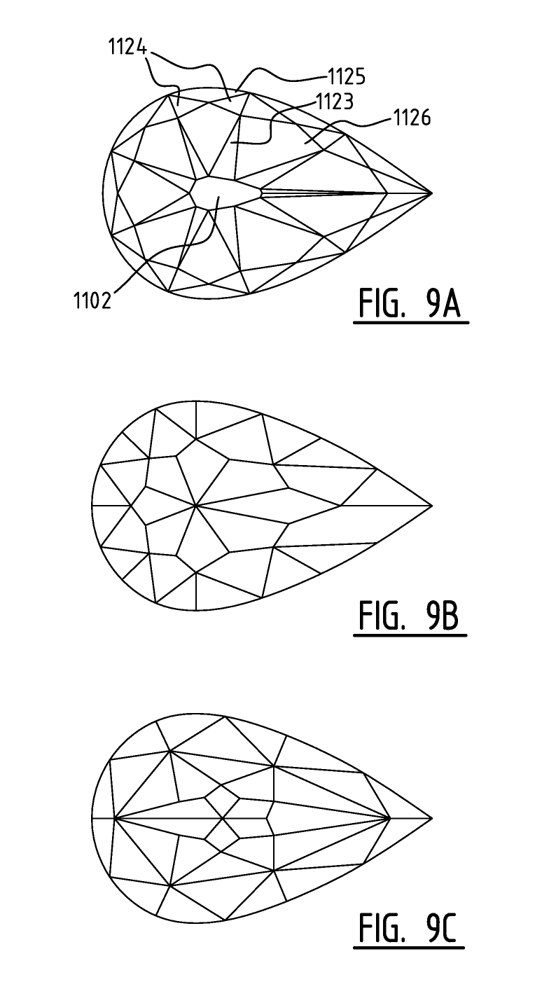

Depending on the flaws and the shape of the rough stone, the culet facet incline and a girdle bezel facet incline can be optimized for the best possible play of light providing for a sufficient brilliance, in other words having optimum optical characteristics. The described cuts are moreover characterized by a larger volume, with the result that the weight expressed in carats increases, which certainly provides an economic advantage. FIGS. 7A and B illustrate schematically the extra volume which can be obtained if a determined cut according to the invention is used. C1 indicates the contour of a traditional round diamond and C2 indicates the contour of a diamond cut according to the invention. The volume Oe gained is hatched. This volume will of course depend on the shape of the rough stone and on the flaws therein, but the skilled person will appreciate that in almost all cases a considerable gain in volume can be obtained with a cut according to the invention.

A possible cut of the present embodiment is designed such that the light incident in the diamond is reflected internally such that the reflection on the girdle is maximized. This principle as illustrated in FIG. 5 and makes a great contribution toward optimization of the optical characteristics. As a result of a suitable choice of the table width and of the angle α2 the light L exiting at the bezels will come largely from light reflected via the girdle and the culet facets. In order to obtain such reflections in the stone the angles δ must be greater than 24 degrees for diamond materials. A suitable value of the angle α2 is particularly important in obtaining this effect.

An additional effect of determined cuts of the present invention is that the optical characteristics are optimized for light exiting not only on the table side of the diamond, but also on the culet side of the diamond. In other words, in respect of the evaluation of the optical characteristics there is not just one preferred orientation of the diamond but there are multiple preferable orientation options for the diamond. This allows the diamond with a cut according to the present invention to be set in different ways while retaining the optimum optical characteristics.

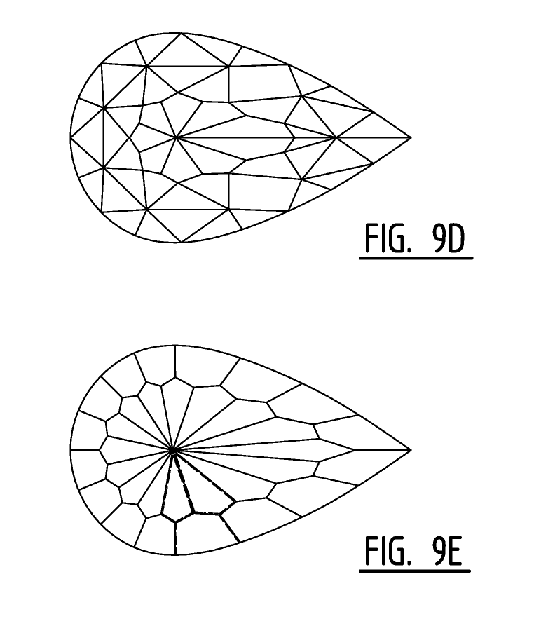

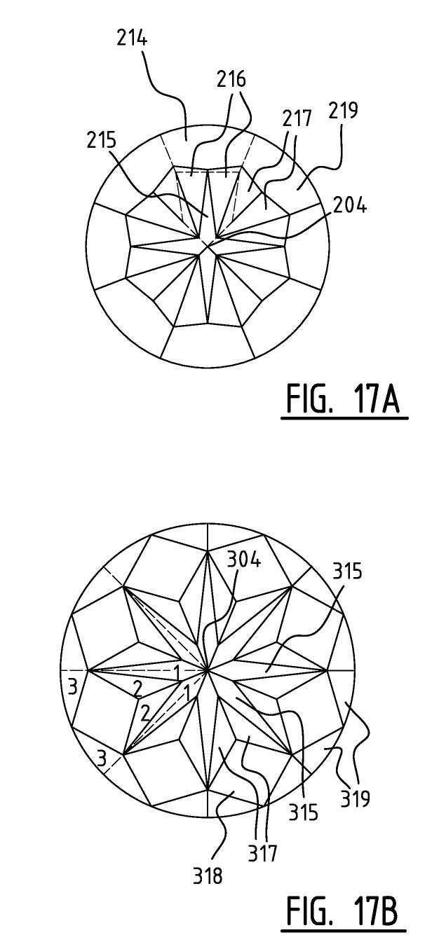

FIGS. 8A-8D show another three variants for the upper part of a stone according to the invention which are by no means limitative and which serve solely for the purpose of illustration. In the variants of FIGS. 8A-8D use is made of a relatively small table 102, 202, 302, 402. For these variants the dimensions of the table will typically be between 1 and 40% of the overall width (diameter) of the stone. In the variant of FIG. 8A use is made of star facets 123, and in each case two half facets 124 and a facet 125 which adjoin the girdle. Use is likewise made in the variant of FIG. 8B of star facets 223 but, instead of in each case two half facets 124 and a facet 125 which adjoin the girdle, facets 224, 225 are here arranged adjoining the girdle. In the variant of FIG. 8C use is made of small star facets 323 on each side edge of table 302. Provided in the variant of FIG. 8D are star facets 423 and facets 425 which adjoin the girdle. FIGS. 16A-C show variants in which the top end of the stone ends in a point 602, 702, 802.

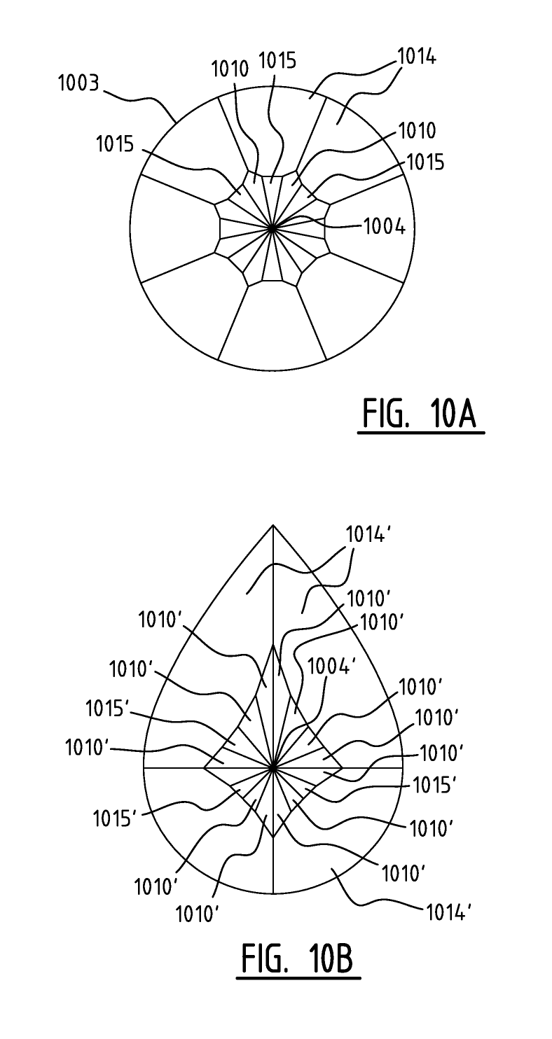

FIGS. 9A-E further illustrate a number of possible and by no means limitative top or bottom views of a pear diamond according to the invention. FIG. 9A is a possible top view of the stone illustrated in FIG. 6C.

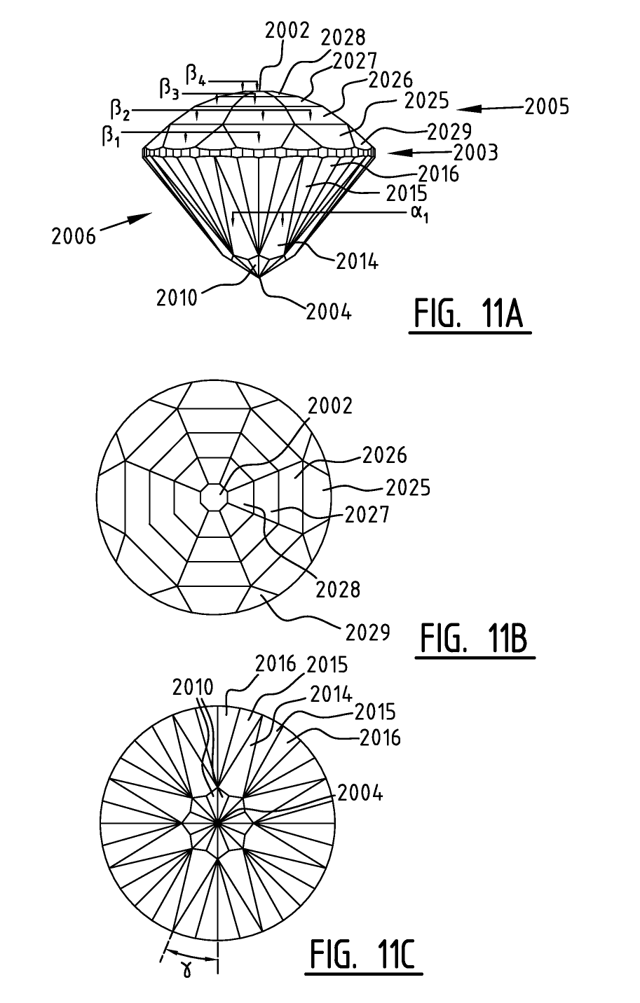

FIGS. 10A and B illustrate two further advantageous embodiments of the lower part of a round and pear diamond according to the invention. Corresponding lower parts can be used in any other type, any other shape or any other cut of diamond. The lower part of FIG. 10A comprises eight girdle pavilion facets 1014 which adjoin eight culet facets 1015. The stone is further finished with half facets 1010 which continue as far as culet 1004. FIG. 10B illustrates a corresponding variant for a pear diamond. In this variant there are provided four girdle pavilion facets 1014′ and four culet facets 1015′. The stone is further finished with half facets 1010′ which extend between culet 1004′ and girdle pavilion facets 1014′.

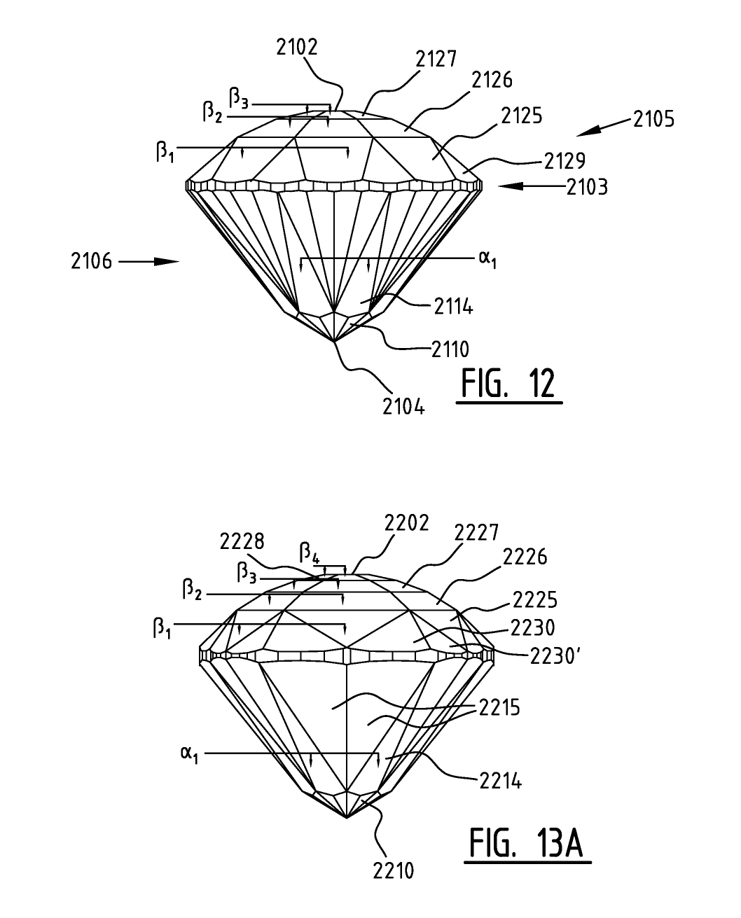

The round diamond of FIGS. 11A-C comprises a lower part or pavilion 2006 with a number of pavilions and with a bottom end or culet 2004; an upper part or crown 2005 with a number of bezels and a table 2002; and a girdle 2003 between the pavilion 2006 and the crown 2005.

As illustrated in FIG. 11A, the pavilions comprise a number of girdle pavilion facets 2014 adjoining the girdle 2003 and a number of culet facets 2010 adjoining the culet. The lower part is finished with halves 2015, 2016 extending at each side of a girdle pavilion facet 2014. The culet facets adjoining the culet consist of sixteen half facets 2010, two for each girdle pavilion facet 2014. The girdle pavilion facets 2014 describe a first angle α1 relative to the plane of the girdle 2003. The culet facets each describe a smaller second angle α2 relative to the plane of the girdle. The average first angle α1 of the girdle pavilion facets lies between 15 and 80 degrees. The average second angle α2 preferably lies between 28° and 36°, and more preferably between 31° en 33°. Preferably, the angles α2 and/or α1 is/are optimized on the one hand for a cut product with the greatest possible volume and on the other for an optimum reflection of the lower part in the upper part.

The girdle bezel facets 2025 are twisted relative to the girdle pavilion facets 2014 through a twist angle γ as best illustrated in the top view of FIG. 11C. The twist angle γ is optimized as a function of the dimensions of the stone in order to obtain the best diamonds light performance, and more in particular in order to obtain a reflection of the lower part in certain bezels and/or in the table. Preferably the lower part is reflected in facets 2026, 2027 and 2028, and optionally also in facets 2025.

In the embodiment of FIG. 11A, the number of bezels intersecting a plane parallel with the girdle equals eight, i.e. the stone comprises eight bezel facets 2025, eight bezel facets 2026, eight bezel facets 2027 and eight bezel facets 2028. The number of pavilions 2014 intersecting a plane parallel with the girdle also equals eight. In other words the stone has eight-fold symmetry. The twist angle γ is substantially equal to the 180 degrees divided by eight, i.e. 22.50 degrees.

The ratio of the width of table 2002 preferably lies between 0.10 and 0.30. The table width and the orientation of the bezel facets 2025-2027 are preferably optimized on the one hand in order to reflect the lower part 2006 in at least a number of the facets of the upper part, and on the other hand for a cut product with the largest possible volume.

The crown comprises table bezel facets 2028 and girdle bezel facets 2025 and a number of intermediary bezel facets 2026, 2027. Between the girdle bezel facets 2025 smaller half facets 2029 are provided to finish the stone. The girdle bezel facets describe a first angle β1 relative to the plane of the girdle. The intermediary bezel facets 2026, 2027 describe second and third angles β2, β3 respectively. The table bezel facets 2028 describe a fourth angle β4 relative to the plane of the girdle. The average first angle β1 of the girdle bezel facets relative to the plane of the girdle lies between 35 degrees and 50 degrees, preferably between 39 degrees and 43 degrees, and is more preferably about 41 degrees. The angles β2, β3, and β4 lie between 5 and 50 degrees, preferably between 30 and 50 degrees, and for instance between 31 and 41 degrees.

The height of the cut product is typically defined as the distance between the top end and the bottom end. In the embodiment of FIGS. 11A-C, the ratio of the height and the width of the girdle lies preferably between 0.60 and 1, and more preferably between 0.75 and 0.85. Also, preferably, the ratio of the height of the girdle and the width of the girdle is 0.02 to 0.1. Further, as illustrated, the girdle can be provided with a large number of facets.

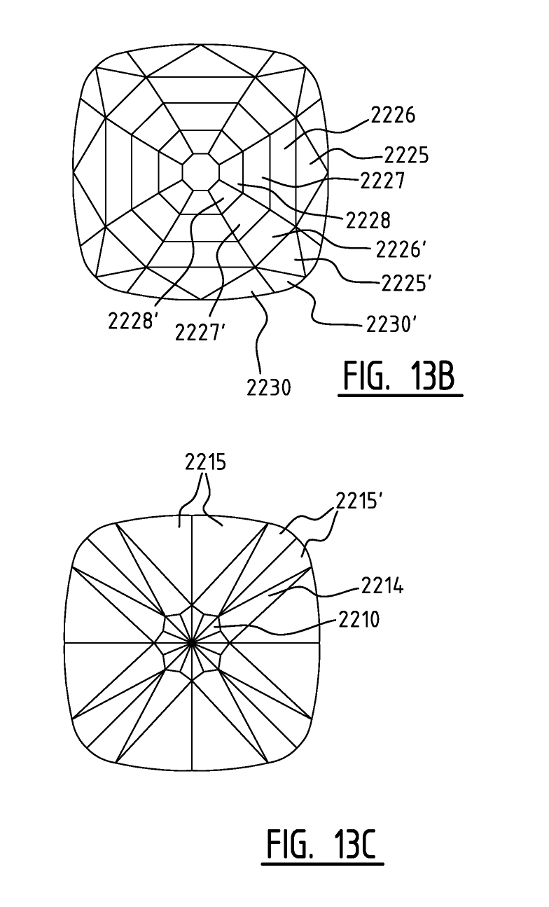

FIG. 12 illustrates a variant of FIG. 12 but with three instead of four bezel facets, see bezel facets 2125, 2126, 2127. The other facets 2102, 2103, 2104, 2110, 2114, 2129 and angles are similar to those described for the variant of FIG. 11A and will not be repeated.

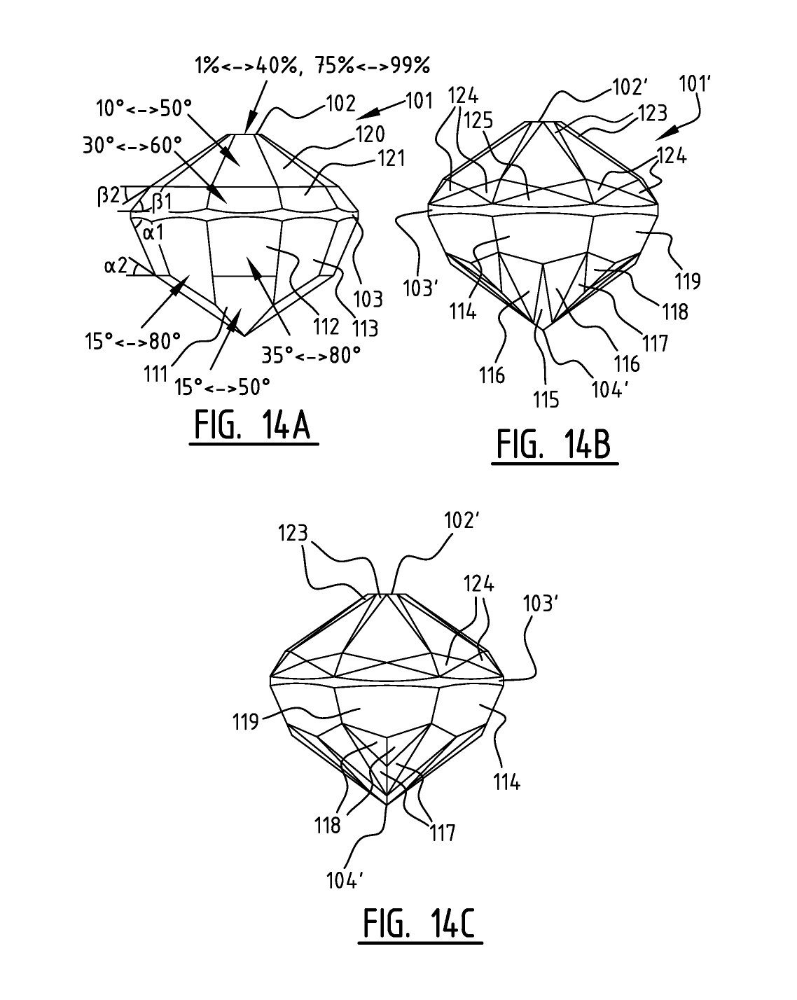

FIGS. 13A-C illustrate another variant similar to the embodiment of FIGS. 11A-C but for a square stone. Moreover, the skilled person will understand that the same type of faceting can be applied on a rectangular stone, an arbitrary polygonal stone, an oval stone or a pear with minor adoptions. In the embodiment of FIGS. 13A-C the position of the girdle pavilion facets 2214 is optimized within the square shape. Centrally at each side of the square, a first group of bezel facets 2225, 2226, 2227, 2228 is centred between two adjacent girdle pavilion facets 2214. In the corners, a second group of bezel facets 2225′, 2226′, 2227′, 2228′ is centred between the two girdle pavilion facets 2214. The stone is finished with upper girdle facets 2230′ in the upper part and lower girdle facets 2215, 2215′ in the lower part.

The skilled person will understand that the embodiments of FIGS. 11A-C, 12 and 13A-C can be easily adapted by the skilled person for obtaining a different more or less than eight pavilion or bezel main facets.

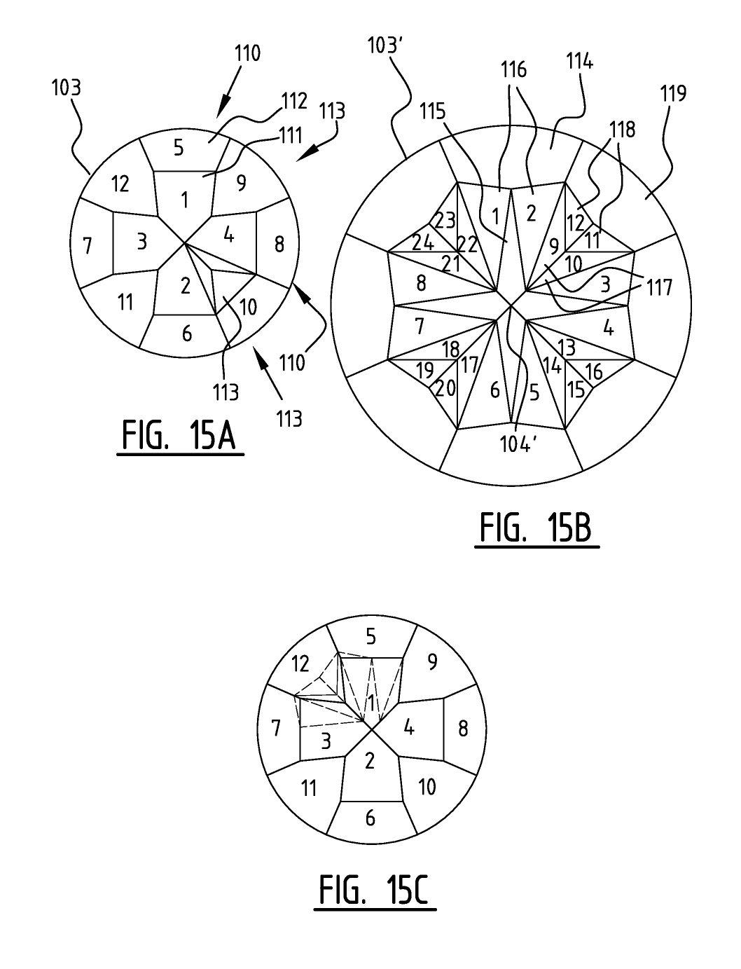

An embodiment of the method of the invention will now be elucidated on the basis of FIGS. 14A-C and 15A-C. As set forth above, the saw plane 1100 for table 1002 is sawn first according to the prior art, after which this saw plane is used as reference for the purpose of performing the further cross work. According to the method of the present invention the table is not used as reference, and this table will typically only be arranged once a part of the cross work has been performed.

FIG. 14A shows a side view of a diamond 101 with a top end in the form of a table 102 (this could also be a point) and a bottom end 104 which can be a point or a small surface and is known under the name culet. The diamond is widest at the position of girdle 103. The lower part of a diamond is characterized by a number of facets between girdle 103 and culet 104. The upper part is in turn characterized by a number of facets between girdle 103 and table 102.

Starting from the rough stone, four facet groups 110 are arranged (shown with hatching in FIG. 2A) as first rough facets (i.e. before table facet 102 is arranged). Each facet group 110 consists of two adjoining facets 111, 112 one above the other. In the shown example use is made of four facet groups 110, although the skilled person will appreciate that it is also possible to make use of two, three or more than four facet groups. Instead of having two adjoining facets 111, 112, it is also possible to make use of one facet or more than two adjoining facets. As seen along the periphery of girdle 103, a pavilion group 113 is arranged in each case between two facet groups 110. In the shown embodiment each pavilion group 113 has one facet, although the skilled person will appreciate that a pavilion group can also consist of multiple adjoining facets. It is thus possible for instance to provide additional pavilion facets 113a, as indicated in broken lines in FIG. 2A.

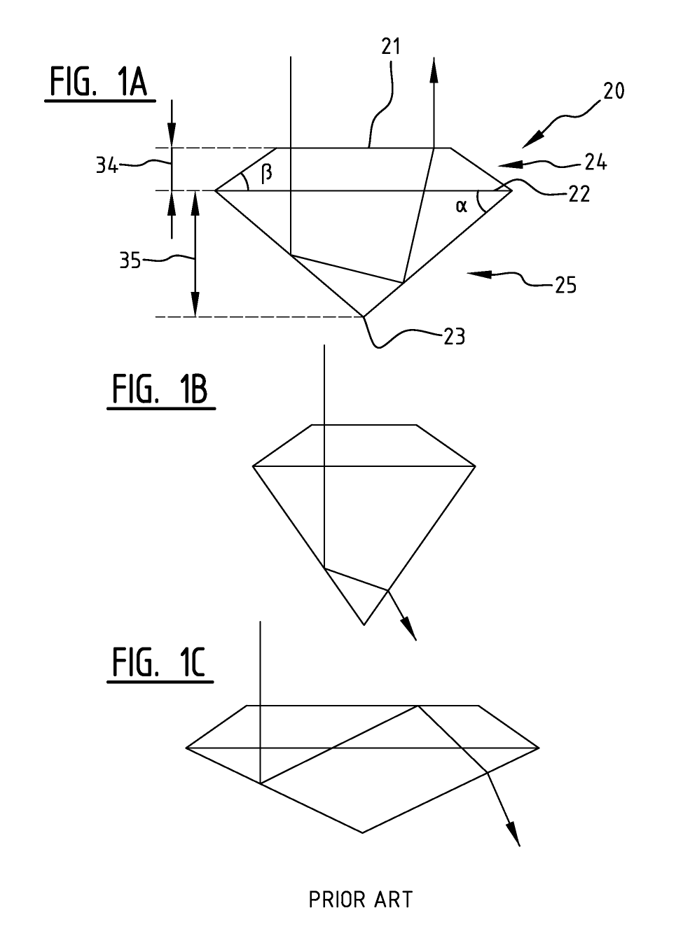

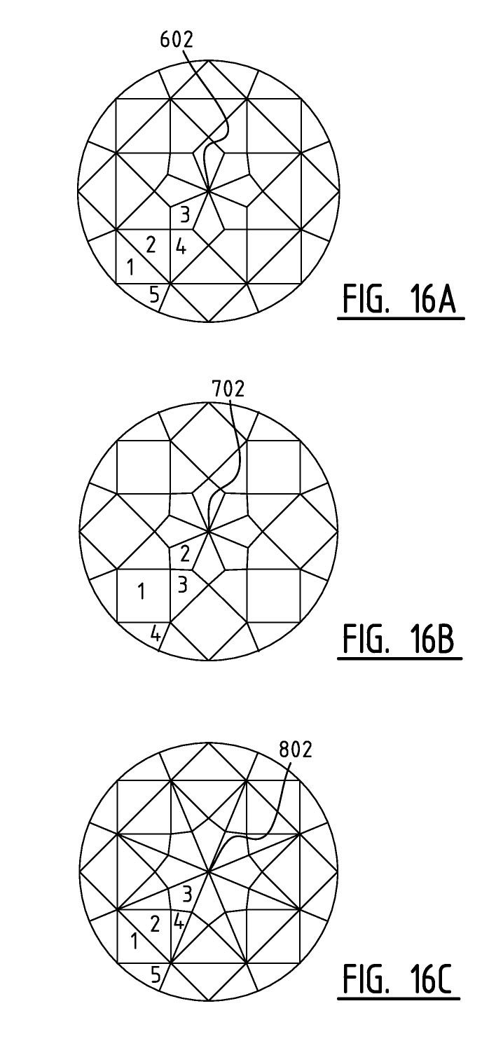

FIG. 15A further illustrates the sequence in which the different facets of the lower part of this embodiment variant are arranged. Opposite facets adjoining culet 104 will typically be arranged first. In the shown example a first pair of opposite facets 111 are thus arranged first, followed by the second pair of opposite facets 111 (see reference numerals 1-4 in FIG. 2A). Facets 112 are then arranged (see reference numerals 5-8 in FIG. 2A). After facet groups 110 have been arranged, pavilions 113 are arranged (see reference numerals 9-12, FIG. 2A). After performing the cross work on the lower part of the diamond the girdle 103 is arranged, and subsequently the rough facets of the upper part (the crown) of the diamond. In the variant shown in FIG. 1A eight bezel groups 120, 121 are arranged, each group consisting of two adjoining facets 120, 121 between table 102 and girdle 103. Facets 121 will typically be arranged before facets 120, and this with some margin. It is however also possible to make use of eight single-faceted bezels, as for a conventional stone. The skilled person will further appreciate that it is possible to depart from the above indicated sequence, and that the pavilion facets 113 can for instance be arranged first, followed by facets 112.

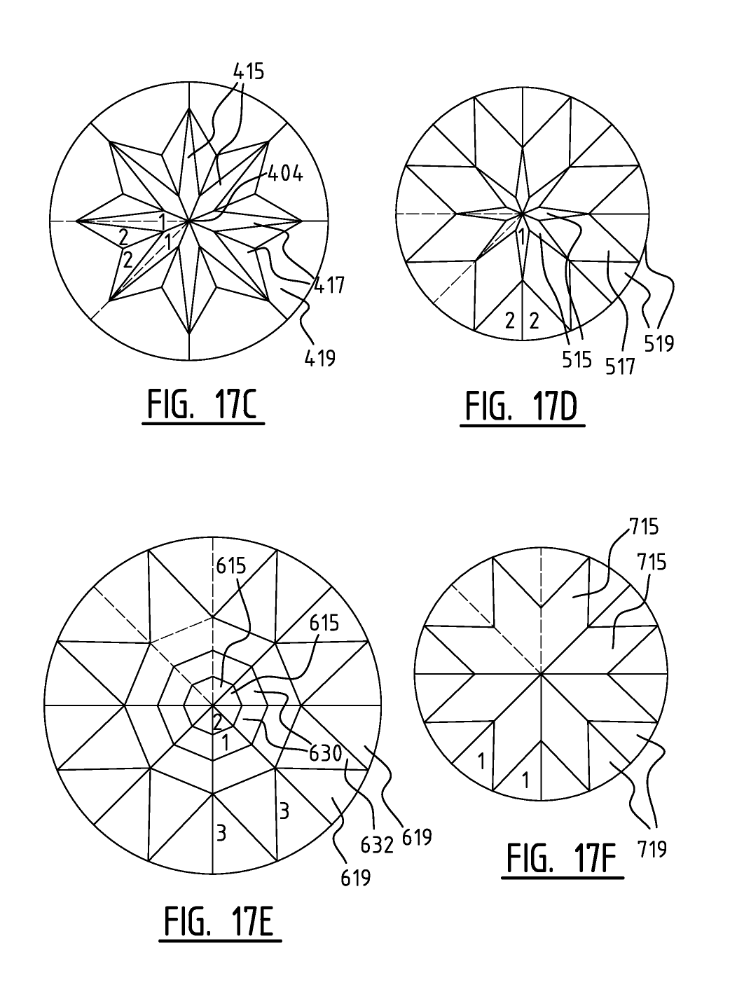

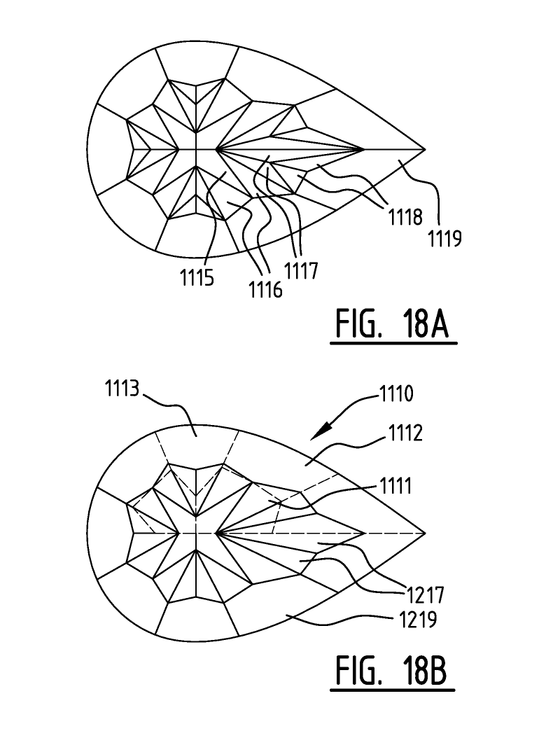

FIG. 15B illustrates the fine polishing work (possible corrections to facets already present and brilliandering) which is carried out after the cross work. During the fine polishing work extra facets are typically arranged in order to further refine the finish of the stone. According to the shown embodiment, the cross facets 111, 112 on the lower part are cut as a brilliant and the pavilion facets 113 are cut as a princess. The upper part will also be further finished once the lower part has been completed. In the shown variant four additional pavilion facets 117, 118 are arranged, although the skilled person will appreciate that these could also be more or fewer facets, see for instance FIG. 17A where only two additional pavilion facets 217 are arranged. Pavilion facet 119 corresponds to pavilion facet 113, wherein this facet is optionally further polished during the fine polishing work.

Cross facets 111, 112 are cut as a brilliant, whereby two additional facets 116 are created. Facet 115 corresponds to facet 111 and facet 114 corresponds to facet 112, wherein these facets are optionally further polished. The skilled person will once again appreciate that the fine polishing work of cross facets 111, 112 can also take place in other manner. A number of examples hereof are shown in FIGS. 17B to 17F.

So as to be perfectly clear, the bottom view of FIG. 15A is shown in FIG. 15C in which the final cut of FIG. 15B is shown in broken lines.

During the fine polishing work on the upper part (see FIG. 14B) additional star facets 123 and half facets 124 can be arranged for further finishing of the stone. Facets 126 further correspond to facets 120, optionally further polished, and facets 121 correspond to facets 125, once again typically further polished.

The skilled person will appreciate that for the upper part many variants are also possible which fall within the scope of the present invention. FIGS. 8A-D and FIGS. 16A to 16C thus show possible top views of the diamond, wherein each of these upper parts can be combined with a random lower part falling within the scope of the invention.

FIGS. 16A to 16C show a further three variants without table, wherein the respective top ends of the stone end in a point 602, 702, 802. Cutting of these upper parts typically comprises of first arranging the cross work and then the fine polishing work:

in FIG. 16A first the facets 1, 2, 3 and 4 and then half facets 5;

in FIG. 16B first the facets 1, 2, 3 and then half facets 4;

in FIG. 16C first the facets 1, 2, 3 and then star facets 4 and half facets 5.

FIGS. 17A to 17F show possible bottom views of a cut diamond according to the invention. FIG. 17A is a variant of the bottom view shown in FIG. 15B, but with fewer pavilion facets: only two additional facets 217 instead of four additional facets 117, 118 as in FIG. 15B. In the variants of FIGS. 17A-17F the cross work consists of arranging eight cross facet groups, as indicated in broken lines. In FIGS. 17B-D and 17F each cross facet group consists of one facet, while in the variant of FIGS. 17A and 17E use is made of two adjoining facets per group. The fine polishing work consists in

FIG. 17B of facets 1, 2 and half facets 3;

FIG. 17C of facets 1, 2;

FIG. 17D of facets 1, and half facets 2;

FIG. 17E of facets 1, 2 and half facets 3;

FIG. 17F of half facets 1.

FIGS. 8A-B finally illustrate an embodiment of the method according to the invention applied to a pear diamond, e.g. the pear diamond of 6C. As illustrated in FIG. 8B, it is on the whole possible to work in the same way as for a round diamond, wherein the cross work is indicated in broken lines. Cross facets 1111, 1112 are arranged first, followed by pavilion facets 1113.

During the fine polishing work the cross facets 1111, 1112 can be cut as a brilliant (see facets 1116 in the variant of FIG. 8A) and pavilion facets 1113 as a princess (see facets 1117, 1118 in the variant of FIG. 8A or facets 1217 in the variant of FIG. 8B).

The upper part of a stone is preferably matched to the lower part such that at least the central part of the pattern of the lower part is reflected in the main facets of the upper part. This pattern will typically further also be visible in the table (if present) and in the lower bezel facets adjoining the girdle, as illustrated in FIG. 4 and explained above. Indicated in FIG. 14A are typical values of the angles which the different facets describe relative to plane P of the girdle. In a prior art conventional stone the pavilions will typically describe an angle of about 41 degrees relative to the plane P running through the girdle, and the bezels an angle of about 34 degrees. According to the invention the angles which the different facets of a cross facet group or bezel facet group describe relative to the girdle plane can vary considerably herefrom. FIGS. 7A and 7B illustrates schematically the extra volume which can be obtained when the method of the invention is used, see above.

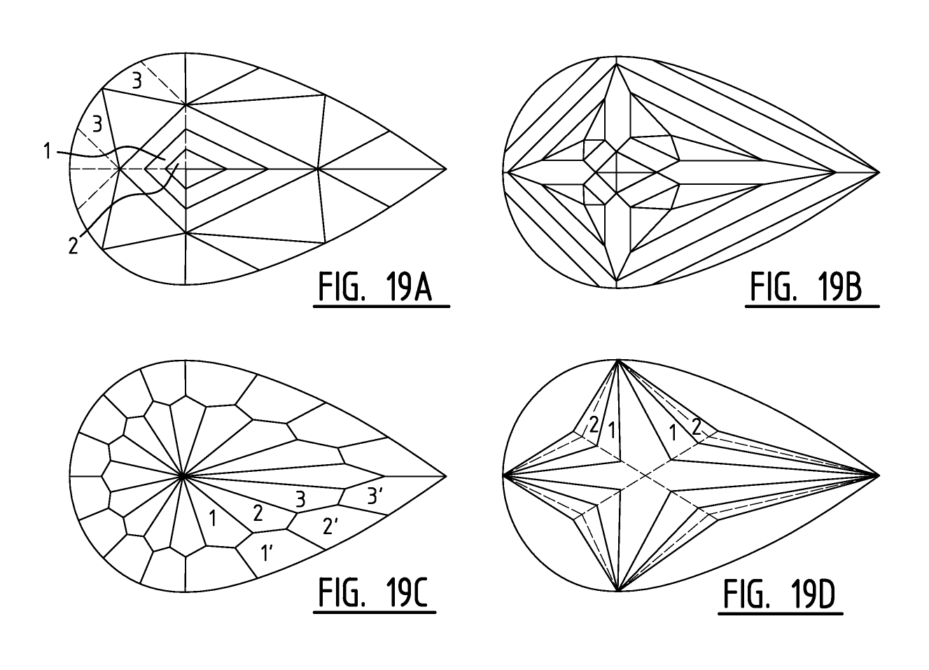

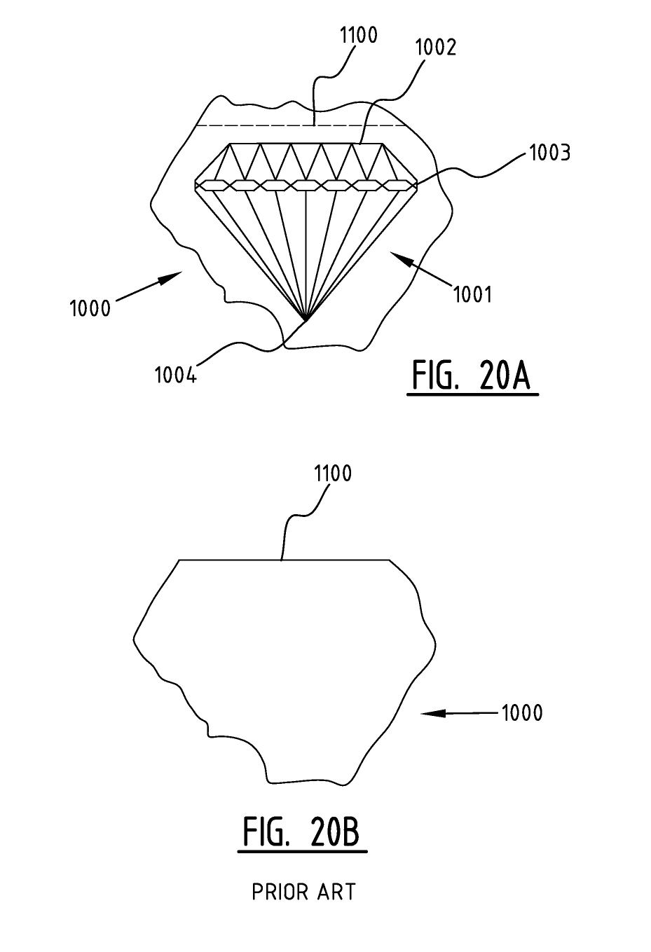

FIGS. 19A-D further illustrate a number of possible top or bottom views of the pear diamond of FIG. 6C. The cross work is indicated in FIGS. 19A, C and D in broken lines when these shapes are used as lower part. The numerals 1, 2 etc. further indicate the sequence of the fine polishing work.

The invention is not limited to the above described exemplary embodiments, and the skilled person will understand that many modifications and variants are possible without departing from the scope of the invention, this scope being defined solely by the following claims. The present invention can be applied to any type, any shape or any cut of diamond, and thus to the existing, conventional fancy cuts (pear, cushion, princess etc.) as well as new, non-conventional and/or not yet existing fancy cuts.

1.-29. (canceled)

30. Cut product manufactured from a (semi)precious stone material, more particularly from natural or synthetic diamond, comprising:
a lower part (pavilion) with a bottom end (culet);
an upper part (crown) having a number of girdle bezel facets and a top end (a point with table width 0 or a top surface (table) with a table width); and
a girdle between said lower part and said upper part,
wherein said lower part comprises a number of girdle pavilion facets which describe a first angle α1 relative to the plane of the girdle and a number of culet facets which each describe a smaller second angle α2 relative to the plane of the girdle; and
wherein the girdle bezel facets are in a twisted position with respect to the girdle pavilion facets in the sense that the bezel facets have perpendicular bisectors which are not coplanar with the perpendicular bisectors of the girdle pavilion facets; and
wherein the ratio of the table width and the width of the girdle is 0 to 0.40.

31. Cut product as claimed in claim 30, wherein, when viewed in a top view of the stone, each bezel facet is centred between two adjoining girdle pavilion facets.

32. Cut product as claimed in claim 30, wherein, a first plane through the centre of each bezel facet and the central vertical axis of the cut product describes a twist angle γ with respect to a second plane through the centre of a corresponding girdle pavilion facet and the central vertical axis of the cut product, wherein the twist angle γ is optimized as a function of the dimensions and/or the model (round, pear, square, rectangular) of the stone in order to obtain a reflection of the lower part in the bezels and/or in the table.

33. Cut product as claimed in claim 32, wherein the cut product is a round stone wherein the twist angle γ is substantially equal to 180 degrees divided by the number of girdle pavilion facets.

34. Cut product as claimed in claim 32, wherein the average of the twist angles γ for each girdle pavilion facet is substantially equal to 180 degrees divided by the number of girdle pavilion facets.

35. Cut product as claimed in claim 30, wherein the culet facets comprise a number of pavilion facets and/or a number of half facets.

36. Cut product as claimed in claim 30, wherein the average second angle α2 lies between 28 and 38 degrees;
wherein preferably the average second angle α2 lies between 28 degrees and 35 degrees, more preferably between 29 degrees and 33 degrees, and is for instance about 31 degrees.

37. Cut product as claimed in claim 30, wherein the ratio of the table width and the width of the girdle is 0 to 0.30, and preferably 0.10 to 0.30 or a point.

38. Cut product as claimed in claim 30, wherein the table width and the orientation of the facets of the upper and lower parts are optimized in order to reflect the lower part in at least a number of the facets of the upper part.

39. Cut product as claimed in claim 30, wherein the girdle pavilion facets are located above the culet facets, wherein each culet facet adjoins the bottom end and each girdle pavilion facet adjoins the girdle;
wherein preferably at least three, and more preferably at least four, and for instance six, seven, eight or more girdle pavilion facets are arranged.

40. Cut product as claimed in claim 30, wherein the culet facets consist of a number of half facets, said number being equal to the double of the number of girdle pavilion facets.

41. Cut product as claimed in claim 30, wherein the culet facets comprise a number of pavilion facets, said number being equal to the number of girdle pavilion facets.

42. Cut product as claimed in claim 30, wherein the average first angle α1 of the girdle pavilion facets lies between 15 and 80 degrees.

43. Cut product as claimed in claim 30, wherein the angles α2 and/or α1 is/are optimized on the one hand for a cut product with the greatest possible volume and on the other for an optimum reflection of the lower part in the upper part.

44. Cut product as claimed in claim 30, wherein the upper part is a crown with table bezel facets and girdle bezel facets, which girdle bezel facets describe a first angle β1 relative to the plane of the girdle, and which table bezel facets describe a second, smaller angle β2 relative to the plane of the girdle;
wherein preferably the average first angle β1 of the girdle bezel facets relative to the plane of the girdle lies between 35 degrees and 50 degrees, preferably between 39 degrees and 43 degrees, and is more preferably about 41 degrees;
wherein preferably the average second angle β2 lies between 5 and 50 degrees, preferably between 30 and 50 degrees, and for instance between 31 and 41 degrees.

45. Cut product as claimed in claim 30, wherein at least three girdle bezel facets and at least three table bezel facets are arranged, preferably at least four and for instance six, seven or eight or more.

46. Cut product as claimed in any of the claims 44, wherein the number of girdle and table bezel facets and the orientation thereof is optimized on the one hand for a cut product with the largest possible volume and on the other for an optimum reflection of the lower part in the upper part.

47. Cut product as claimed in claim 30, wherein the height of the cut product is the distance between the top end and the bottom end, wherein the ratio of the height of the cut product and the width of the girdle lies between 0.60 and 1, and more preferably between 0.75 and 0.85; and/or
wherein the ratio of the height of the girdle and the width of the girdle is 0.02 to 0.1; and/or
wherein the girdle is provided with a large number of facets; and/or
wherein the lower part, and in particular the culet, and/or the upper part are cut as a brilliant; and/or
wherein the pavilion facets are cut as a princess.

48. Computer program for determining an optimum three-dimensional cut model for a cut product manufactured from a (semi)precious stone material, more particularly from natural or synthetic diamond, comprising:
a lower part (pavilion) with a bottom end (culet);
an upper part (crown) having a number of girdle bezel facets and a top end (a point with table width 0 or a top surface (table) with a table width); and
a girdle between said lower part and said upper part,
wherein said lower part comprises a number of girdle pavilion facets which describe a first angle α1 relative to the plane of the girdle and a number of culet facets which each describe a smaller second angle α2 relative to the plane of the girdle; and
wherein the girdle bezel facets are in a twisted position with respect to the girdle pavilion facets in the sense that the bezel facets have perpendicular bisectors which are not coplanar with the perpendicular bisectors of the girdle pavilion facets; and
wherein the ratio of the table width and the width of the girdle is 0 to 0.40.

49. Computer program as claimed in claim 48, wherein the number of cross facets of each cross facet group and the orientation thereof is optimized for a cut model with the largest possible volume, taking into account the other required properties of the stone; and/or wherein the number of bezel facets of each bezel facet group and the orientation thereof is optimized for a cut model with the largest possible volume, taking into account the other required properties of the stone.
